(19) United States
(12) Patent Application Publication
(10) Pub. No.: US 2004/0181761 A1
(43) Pub. Date: Sep. 16, 2004

(54) Circuit simulation for a circuit including transistors

(75) Inventor: Makoto Kidera, Tokyo (JP)

Correspondence Address: McDERMOTT, WILL & EMERY, 600 13th Street, N.W., Washington, DC, 20005-3096, US

(73) Assignee: RENESAS TECHNOLOGY CORP.

(21) Appl. No.: 10/694,785

(22) Filed: Oct. 29, 2003

(30) Foreign Application Priority Data
Mar. 11, 2003 (JP) 2003-64866

(51) Int. Cl. G06F 17/50

(52) U.S. Cl. 716/2

(57) ABSTRACT

For simulation of an electric characteristic of a circuit including transistors, a plurality of transistors are arranged in a matrix pattern on the basis of sizes of the transistors, and data of the electric characteristic measured on first transistors among the plurality of transistors are stored in the matrix pattern. When a position of a second transistor different from the first transistors is specified in the matrix pattern, data of the electric characteristic of the second transistor are determined according to interpolation rules by using the measured data of the one or more first transistors if there are one or more first transistors in the plurality of first transistor at one or more positions adjacent to the position of the second transistor in the matrix pattern.

### BACKGROUND OF THE INVENTION

1. Field of the Invention

The present invention relates to simulation of electric characteristics of a circuit including metal-oxide semiconductor field-effect transistors.

2. Description of Related Art

In simulation of a circuit design including metal-oxide semiconductor field-effect transistors (hereinafter referred to as MOSFETs or MOS transistors), model parameter sets defining channel length/width dimension of MOS transistors are usually prepared, and an optimum model parameter set is selected among them for the channel length/width dimension of each individual transistor used for the circuit design. The circuit simulation is then performed by using the selected model parameter set (see, for instance, Japanese Patent laid-open Publication No. 10-65159 (1998)). The model parameters of MOS transistors are available only for the sizes of MOS transistors included in a test element group in a semiconductor device which have been provided for the measurement of electric characteristics. In table model that is a different technique for circuit simulation, the circuit simulation is performed, without using an analytical model, with reference to a look-up table of measured electric characteristics of transistors.

In the above-mentioned simulation techniques, the measured data on devices that have the same size as those employed in the circuit design are not necessarily available owing to factors such as a limited size of the wafer top area and/or the finished shape depending on the fabrication process. A more preferable model parameter set has so far been determined by optimizing the model parameters.

Since direct current electric characteristics of a MOS transistor vary with sizes of channel length/width thereof, it is required for more accurate simulation to obtain electric characteristics for a size different from the existing sizes of the device. Then, if no device with the required size is available, it would be proposed to perform simulation of electric characteristics by using a prediction depending on the shape of circuit simulation model.

However, when the prediction is used, the accuracy of the simulation largely depends on predicted results of electric characteristics that depend on the shapes of model. Even though the required accuracy is satisfied at the measured points, characteristics that will not exist actually may be obtained in the simulation at a size other than those measured actually, depending on the parameters extracted for the size. In order to prevent such a case, it is needed to increase the actually measured sizes used for the optimization and to increase binding conditions when parameters for circuit simulation models are extracted. Also for the table model for circuit simulation employing actual values for respective sizes, it will be crucial how to increase the prediction accuracy from the table data of actually measured sizes in order to simulate data on a size different from the actually measured sizes.

### SUMMARY OF THE INVENTION

It is an object of the present invention to predict electric characteristics of transistors of desired sizes more accurately based on the measured data of transistors.

In one aspect of the invention, for simulation of an electric characteristic of a circuit including transistors, a plurality of transistors are arranged in a matrix pattern on the basis of sizes of the transistors, and data of the electric characteristic measured on first transistors among the plurality of transistors are stored in the matrix pattern. When a position of a second transistor different from the first transistors is specified in the matrix pattern, data of the electric characteristic of the second transistor are determined according to interpolation rules by using the measured data of the one or more first transistors if there are one or more first transistors in the plurality of first transistor at one or more positions adjacent to the position of the second transistor in the matrix pattern. Further, when a position of a further second transistor different from the second transistor is specified in the matrix pattern, data of the electric characteristic of the further second transistor are determined according to the interpolation rules by using the measured data of the one or more first transistors and/or the interpolated data of the second transistor if there are one or more first transistors in the plurality of first transistor and/or one or more second transistor on which the interpolated data have already been obtained at one or more positions adjacent to the position of the further second transistor in the matrix pattern.

An advantage of the invention is that the circuit simulation can be performed based on measured data when the measured data are not available for all the sizes of transistors in the matrix pattern.

### BRIEF EXPLANATION OF THE DRAWINGS

These and other objects and features of the present invention will become clear from the following description taken in conjunction with the preferred embodiments thereof with reference to the accompanying drawings, and in which:

FIG. 1 is a block diagram of an arrangement of a simulation system according to a first embodiment of the present invention;

FIG. 2 is a flowchart of a flow of processes performed by the simulation system;

FIG. 3 is a diagram for concretely illustrating steps of a first stage of data interpolation processes;

FIG. 5 is a diagram for explaining existing TEG sizes required for obtaining interpolated values of specified non-existing TEG sizes;

FIG. 6 is a diagram for illustrating a condition in which interpolated values of adjacent to non-existing TEG sizes are obtained on the basis of measured values of existing TEG sizes in three directions;

FIG. 7 is a diagram for explaining a method for generating an interpolated value between vertexes on the basis of obtained values for the vertexes;

FIG. 8 is a diagram of an example for circuit simulation using table models; and

FIG. 9 is a diagram for explaining a function g of gate size L/W obtained from a plurality of measured points.

### DESCRIPTION OF THE PREFERRED EMBODIMENTS

Referring now to the drawings, wherein like reference characters designate like or corresponding parts throughout the several views, embodiments of the present invention will now be explained.

First Embodiment.

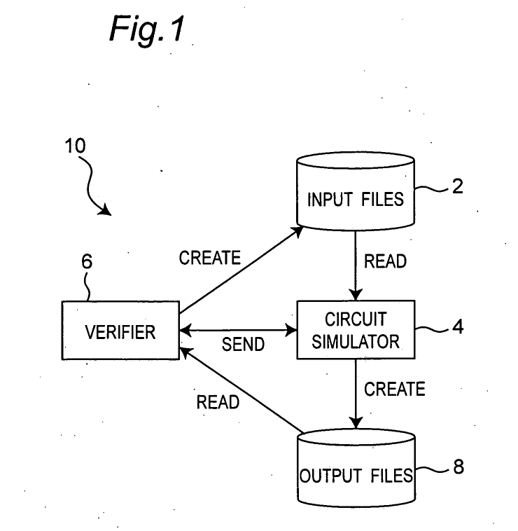

FIG. 1 shows a simulation system 10 according to the first embodiment of the invention for simulating electric characteristics of metal oxide semiconductor field effect transistors (MOSFETs) in a circuit design.

The simulation system 10 has a circuit simulator 4 and a verifier 6. An input file 2 are a generic term for a file or files generated by the verifier 6 and read by the circuit simulator 4, and an output file 8 is a generic term for a file or files generated by the circuit simulator 4 and read by the verifier 6. The numbers of the input file 2 and the output file 8 are not necessarily limited to one. The verifier 6 creates the input file 2 for a circuit design. The circuit simulator 4 reads the input file 2, sets various conditions and performs circuit simulation with reference to the input file 2, and results of the simulation are output to the output file 8. After the processing in the circuit simulator 4 is completed, the verifier 6 reads the output file 8 created by the circuit simulator 4, and starts to verify the simulated circuit with reference to the output file 8. Results of the verification are output as the input file 2.

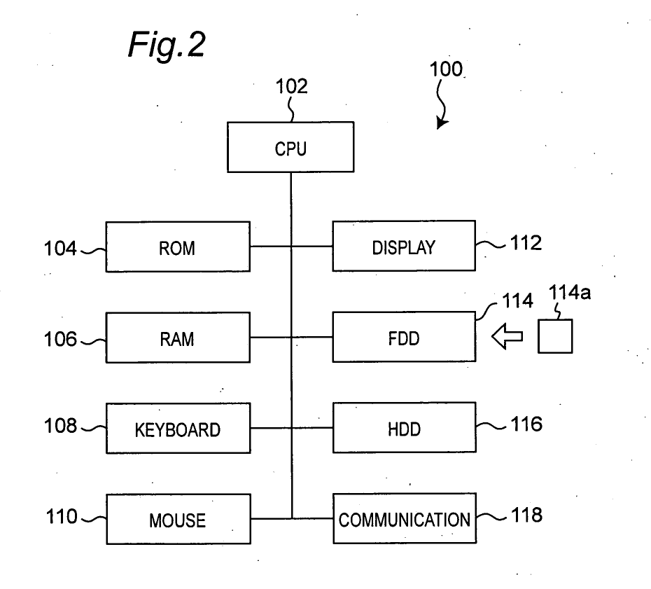

The circuit simulator 4 and the verifier 6 are realized, for example, as a computer 100 shown in FIG. 2. The computer 100 has a central processing unit 102 (hereinafter referred to as CPU) for controlling the entire system, a read-only memory (ROM) 104 for storing programs and data, a random access memory (RAM) 106 used as a work area, a keyboard 108, a mouse 110, a display device 112, a flexible disk drive 114 for a flexible disk 114a and a hard disk drive 116 as secondary storage devices for storing data such as the input file 2 and a simulation and verification program to be executed by the CPU 102, and a communication device 118 to be connected to an external computer and the like in a network. The input file 2 and the simulation program are stored in the hard disk drive 116 in this example. Alternatively, the circuit simulator 104 and the verifier 6 are realized as two computers, each having similar components to the counterparts in the computer 100. A simulation program for the circuit simulator 4 and input files 2 are stored in a hard disk drive or the like in one of the two computers, while a verification program for the verifier 6 and the output file 8 are stored in a hard disk drive or the like in the other of the two computers.

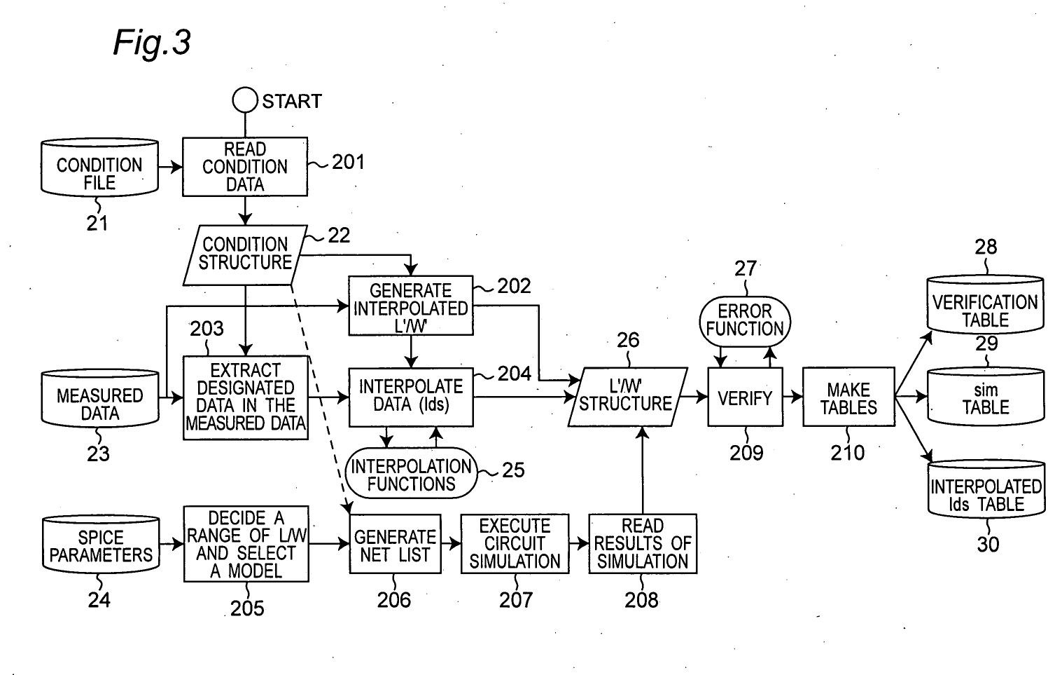

Processes in the simulation system 10 will now be explained with reference to a flow shown in FIG. 3 of the simulation and verification program in the simulation system 10. In FIG. 3, simulation of a circuit design performed by the circuit simulator 4 corresponds to steps S201 to S208, and verification performed by the verifier corresponds to steps S209 to S210. A condition file 21, measured data 23 and SPICE parameters 24 correspond to the input file 2 for the circuit simulator 4 shown in FIG. 1. Data generated at steps in the flow are temporally stored as a part of the output file 8 in a memory device such as the hard disk drive 114.

First, as shown in FIG. 3, the condition file 21 to which condition data for verification are written is read and stored in a condition structure 22 (step S201). In the condition file 21, generation rules on gate sizes of MOS transistors to be verified, bias conditions therefor and the like are described (a format thereof will be described later). The condition structure 22 has a data structure to be referred by the CPU 102 when the condition data are required. By using the condition structure 22 and measured data 23, channel length/width (length and width are hereinafter referred to as “L” and “W”) of a MOS transistor to be verified are generated as interpolated L′/W′ (step S202). The generated L′ and W′ are stored in a L′/W′ structure 26 used for verification. The interpolated L′/W′ will be explained later with reference to FIG. 4 or the like.

The measured data 23 are electric characteristics (drain-source current I_{ds} in this example) of the MOSFETs which have been measured actually, and they will be used as reference data when the verification is performed. The measured data 23 are input to a SPICE parameter extraction tool.

On the basis of the condition structure 22 and the measured data 23, data designated are extracted among the measured data 23 (step S203). Interpolation of the current data (Ids) is performed on the basis of the extracted measured data and the interpolated L′/W′ generated at step S202 in order to predict an interpolated value (step S204). Interpolation functions 25, including functions of Eqs. (1) to (5) explained later, are called for the interpolation. The functions 25 may be either stored in the input file 2 or held in the circuit simulator 4. The predicted interpolated value is incorporated into a part of the L′/W′ structure 26.

In parallel to the above-mentioned processing at steps S203 and thereafter, a different processing is performed. An effective range of L/W is decided on the basis of SPICE parameters 24 which are model parameters for circuit simulation (step S205). The SPICE parameters 24 are given to a model representing operating characteristics such as physical sizes and basic characteristics of a non-linear device such as a MOS transistor, necessary for the simulation. A model or the like is selected and a net list is generated in accordance with a size of a MOS transistor to be verified on the basis of the condition structure 22, the L′/W′ structure 26, the model parameter file 24 and the decision at step S205 (S206). The net list has data in a known format, generally stored in a circuit simulator input file (tmp_netlist). Then electric characteristics of the circuit are simulated according to the net list, and the result of the simulation is output to the output file (step S207). Then, the obtained current value corresponding to L′/W′ to be verified is incorporated in the L′/W′ structure 26 according to the output file (step S208).

Next, a flow for the verification is explained. Verification and evaluation of errors between the interpolated values and the simulated values are performed on the basis of the L′/W′ structure 26 (step S209). Alternatively, the errors may be evaluated by using an error function 27, which may either be stored in the input file 2 or included in the program for the circuit simulation. The verification results, the simulation results and the interpolated I_{ds} are then output as files of tables 28-30 in a two-dimensional matrix of L′ and W′ (step S210).

The tables 28, 29 and 30 obtained at step S210 are explained. A verification table 28 is output for the verification result, wherein errors between simulation results and interpolated values obtained from the measured values are listed. A simulation (sim) table 29 is output for the simulation results. An interpolated I_{ds} table 30 is output for the interpolated I_{ds} obtained from the actually measured values. These three files 28-30 are output as the output file 8, in a text format disposed in a two-dimensional matrix on MOS gate length (L) and gate width (W). Table 1 shows an example of the interpolated Ids table 30.

TABLE 1
Table of interpolated I_{ds} as a function of
length (L) and width (W) of MOS transistor

| | L[μm] | | | | | | | |
|---|---|---|---|---|---|---|---|---|
| W [μm] | 0.5 | 0.52 | 0.54 | 0.56 | 0.58 | 0.6 | 0.62 | 0.64 |
| 9.99 | 2.264E−03 | 2.186E−03 | 2.114E−03 | 2.047E−03 | 1.985E−03 | 1.927E−03 | 1.872E−03 | 1.821E−03 |
| 9.97 | 2.259E−03 | 2.182E−03 | 2.110E−03 | 2.043E−03 | 1.981E−03 | 1.922E−03 | 1.868E−03 | 1.817E−03 |
| 9.95 | 2.254E−03 | 2.177E−03 | 2.105E−03 | 2.038E−03 | 1.976E−03 | 1.918E−03 | 1.864E−03 | 1.813E−03 |
| 9.93 | 2.249E−03 | 2.172E−03 | 2.100E−03 | 2.034E−03 | 1.972E−03 | 1.914E−03 | 1.860E−03 | 1.809E−03 |
| 9.91 | 2.244E−03 | 2.167E−03 | 2.096E−03 | 2.029E−03 | 1.967E−03 | 1.910E−03 | 1.858E−03 | 1.805E−03 |
| 9.89 | 2.239E−03 | 2.162E−03 | 2.091E−03 | 2.025E−03 | 1.963E−03 | 1.908E−03 | 1.852E−03 | 1.801E−03 |
| 9.87 | 2.234E−03 | 2.158E−03 | 2.086E−03 | 2.020E−03 | 1.959E−03 | 1.901E−03 | 1.848E−03 | 1.787E−03 |
| 9.85 | 2.229E−03 | 2.153E−03 | 2.082E−03 | 2.016E−03 | 1.954E−03 | 1.897E−03 | 1.843E−03 | 1.793E−03 |
| 9.83 | 2.224E−03 | 2.148E−03 | 2.077E−03 | 2.011E−03 | 1.950E−03 | 1.893E−03 | 1.839E−03 | 1.789E−03 |
| 9.81 | 2.219E−03 | 2.143E−03 | 2.072E−03 | 2.007E−03 | 1.946E−03 | 1.888E−03 | 1.835E−03 | 1.785E−03 |
| 9.79 | 2.215E−03 | 2.138E−03 | 2.068E−03 | 2.002E−03 | 1.941E−03 | 1.884E−03 | 1.831E−03 | 1.781E−03 |
| 9.77 | 2.210E−03 | 2.134E−03 | 2.063E−03 | 1.998E−03 | 1.937E−03 | 1.880E−03 | 1.827E−03 | 1.777E−03 |
| 9.75 | 2.205E−03 | 2.129E−03 | 2.058E−03 | 1.993E−03 | 1.932E−03 | 1.876E−03 | 1.823E−03 | 1.773E−03 |
| 9.73 | 2.200E−03 | 2.124E−03 | 2.054E−03 | 1.989E−03 | 1.928E−03 | 1.872E−03 | 1.819E−03 | 1.769E−03 |
| 9.71 | 2.195E−03 | 2.119E−03 | 2.049E−03 | 1.984E−03 | 1.924E−03 | 1.867E−03 | 1.815E−03 | 1.765E−03 |
| 9.69 | 2.190E−03 | 2.114E−03 | 2.045E−03 | 1.980E−03 | 1.919E−03 | 1.863E−03 | 1.810E−03 | 1.761E−03 |
| 9.67 | 2.185E−03 | 2.110E−03 | 2.040E−03 | 1.975E−03 | 1.915E−03 | 1.859E−03 | 1.808E−03 | 1.757E−03 |
| 9.65 | 2.180E−03 | 2.105E−03 | 2.035E−03 | 1.971E−03 | 1.911E−03 | 1.855E−03 | 1.802E−03 | 1.753E−03 |

Next, the interpolation of data at step S204, one of the major features of the present embodiment, is explained in detail. In the present embodiment, current value data (I_{ds}) of a target size (or position) is obtained on the basis of measured values of sizes of transistors for which the measured values of the current exist.

When it is difficult to test various patterns of an actual element, a test element group (TEG) as a test pattern is formed in a part of in a semiconductor device, to evaluate target characteristics or shapes of the element. In the present embodiment, a so-called TEG including various sizes of MOS transistors is used. The model parameter sets are obtained by measuring electric characteristics of the MOS transistors on the MOS transistors in the TEG. However, the number of the MOS transistors in the TEG is limited, and MOS transistors of all the sizes necessary for simulation cannot be measured. Then, the interpolation at step S204 is performed.

The interpolation is performed in two steps. More particularly,

(A) a current value (I_{ds}) of a target of simulation having a size for which no measured current value exists is interpolated on the basis of measured values of sizes for which measured current values are available.

(B) Then, an interpolated value at an arbitrary size is obtained on the basis of data including actually measured values and the interpolated values.

The sizes of MOS transistors in the TEG are determined so as to be positioned in a two-dimensional matrix pattern of sizes of length (L) and width (R), or in a lattice-like manner, as shown in FIG. 4. In the matrix pattern, the length and width are increased in the right direction and in the upward direction. The possibility of interpolation can be decided in the matrix pattern of length (L) and width (R). If a size non-existent in the TEG is at a position interposed by two positions for sizes existent in the TEG, the above-mentioned interpolation step A is performed. Further, if a size non-existent in the TEG is at a position adjacent to positions of sizes existent in the TEG and/or the position interpolated at step A, the above-mentioned interpolation step B is performed.

The interpolation at step S204 is explained with reference to an example shown in FIG. 4. In the topmost matrix shown in FIG. 4, marks “◯” and “●-” represent model patterns of transistors for non-existing TEG size and for existing TEG size. Therefore, the mark “◯” of non-existing TEG size presents a size for which no measured value exists, while the mark “●” of existing TEG size presents a size for which measured value exists. The matrix pattern of model is created and stored in the second memory device 116 in the computer 100.

Referring to FIG. 4, at step S2041, measured values of existing TEG sizes are input in the matrix pattern to positions represented in directions L and W. At step S2042, a position of non-existing TEG size interposed by two positions of existing TEG sizes having actually measured values in direction L or direction W (non-existing TEG sizes A to D in this example) are specified. Then at step S2043, interpolation for the specified size is performed.

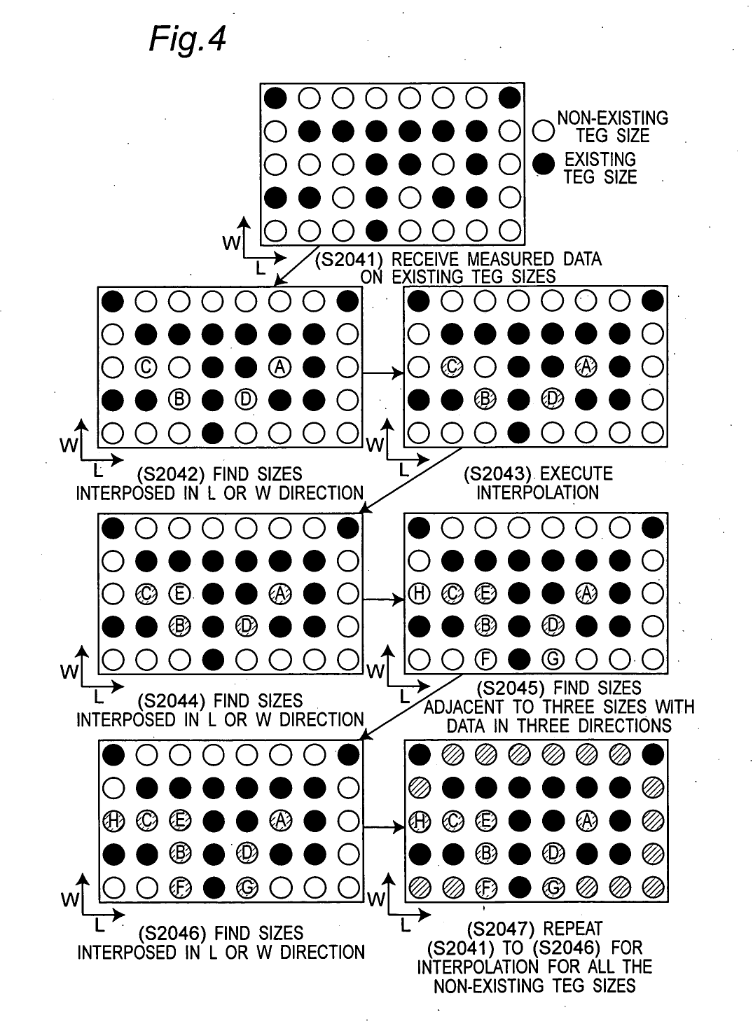

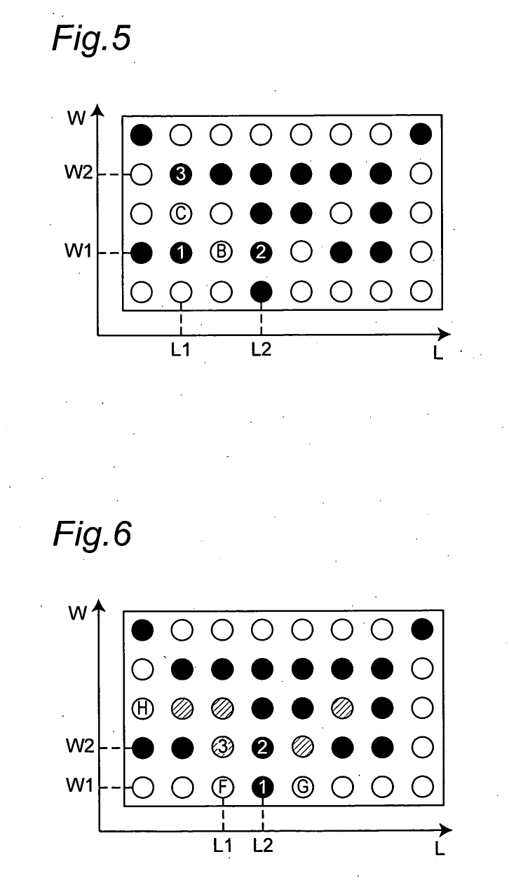

The interpolation in direction L will here explained with reference to FIG. 5 which illustrates the existing TEG sizes required for obtaining interpolated values of the specified non-existing TEG size. As for the interpolation in direction L, non-existing TEG sizes B and D are targets. In FIG. 5, only the non-existing TEG size B is illustrated, and only the non-existing TEG size B is explained here. The size of L/W of this non-existing TEG size B is denoted to be Lb/Wb, respectively. The current of the existing TEG size “1” is denoted to be 11, while the current of the existing TEG size “2” is denoted to be 12. The interpolated current Ids for the non-existing TEG size B may be obtained from Eq. (1).

$${I}_{ds} = \frac{Wc}{Lc} \times \frac{( W2 - Wc ) \times \frac{L1}{W1} \times I1 + ( Lb - L1 ) \times \frac{L2}{W2} \times I2}{L2 - L1} . \qquad ( 1 )$$

The value for the non-existing TEG size D may be similarly interpolated.

On the other hand, targets of interpolation in direction W will be non-existing TEG sizes A and C. In FIG. 4, only the non-existing TEG size C is illustrated, and only the non-existing TEG size C is explained here. The size of L/V of this non-existing TEG size C is denoted to be Lc/Wc, respectively. The current of the existing TEG size “3” is denoted to be 13. The interpolated current Ids for the non-existing TEG size C may be obtained from Eq. (2).

$${I}_{ds} = \frac{Wc}{Lc} \times \frac{( W2 - Wc ) \times \frac{L1}{W1} \times I1 + ( Wc - W1 ) \times \frac{L1}{W2} \times I3}{W2 - W1} . \qquad ( 2 )$$

The value for the non-existing TEG size A may be similarly interpolated.

Again referring to FIG. 4, current values for the non-existing TEG sizes A to D are interpolated at step S2043 in this manner, and the TEG sizes A to D subjected to the interpolation are regarded as existing TEG sizes thereafter. In FIG. 4, the existing TEG sizes subjected to the interpolation are indicated by hatching.

Next, at step S2044, a non-existing TEG size interposed in direction L or W by existing TEG sizes including the new existing TEG sizes A to D are specified. In this case, non-existing TEG size E will be a target. As for the non-existing TEG size E, it is possible to perform interpolation in both directions L and W. Then, the interpolation is performed on the target.

Further, interpolation of current values for a non-existing TEG size adjacent to three existing TEG sizes will be performed. For this purpose, at step S2045, a non-existing TEG size adjacent to three existing TEG sizes is specified. Here, non-existing TEG sizes F, G and H will be targets. Next, at step S2046, interpolation is performed for the three non-existing TEG sizes.

Interpolation of current value (I_{ds}) for the non-existing TEG size F at step S2046 will now be explained with reference to FIG. 6 illustrating interpolation for a non-existing TEG size with reference to three positions of existing TEG sizes in three directions. The current value of existing TEG size “1” is denoted to be I1, that of existing TEG size “2” to be I2 and that of existing TEG size “3” to be I3. The interpolated value Ids of the non-existing TEG size F can be given by Eq. (3).

$${I}_{ds} = \frac{Wf}{Lf} \times I1 + \frac{\frac{L1}{W2} \times I3 - \frac{L2}{W2} \times I2}{L2 - L1} \times ( L2 - L1 ) . \qquad ( 3 )$$

Current values for the non-existing TEG sizes G and H can be similarly obtained. When the current values for the non-existing TEG sizes F to H are interpolated, the interpolated TEG sizes F to H will be regarded as existing TEG sizes F to H thereafter.

Again referring to FIG. 4, the interpolation for non-existing TEG sizes adjacent to three existing TEG sizes is performed at step S2046 as explained above. Thereafter, the steps S2041 to S2046 are repeated on the entire matrix on the basis of the above-described interpolation rules (step S2047). That is, interpolation is repeated for a non-existing TEG size interposed by two existing TEG sizes and for a non-existing TEG size adjacent to three existing TEG sizes. In this manner, all the existing TEG sizes may be interpolated on the basis of the existing TEG sizes and they are treated as existing TEG sizes thereafter.

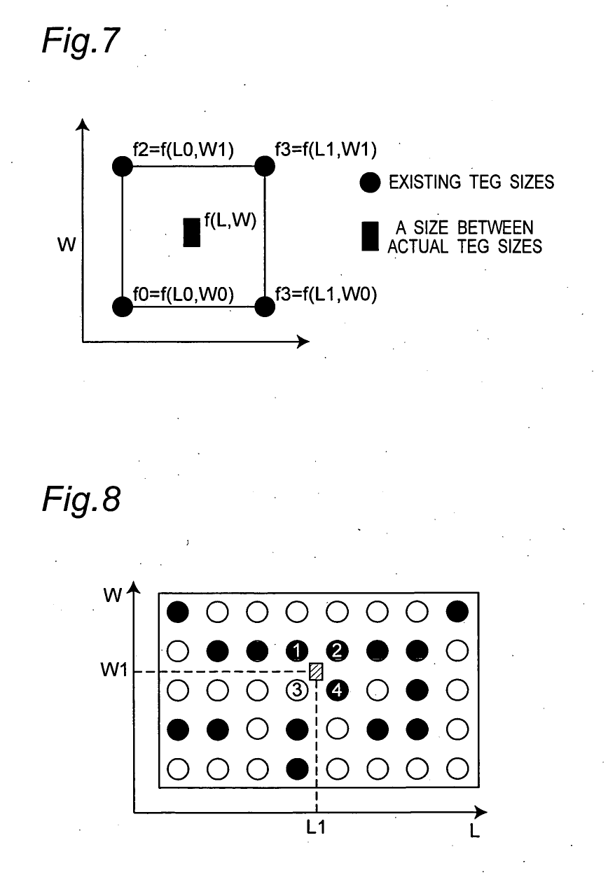

Current values for all the TEG sizes have thus been obtained through the processes explained with reference to FIG. 4. Next, referring to FIG. 7, it is explained how an interpolated value is obtained between vertexes where the TEG sizes are regarded as vertexes. FIG. 7 explains a method for generating an interpolated value between vertexes on the basis of values for the vertexes. For instance, suppose that current value (I_{ds}) for point “▪” shown in FIG. 7 is to be obtained. As illustrated in Eq. (4), the current value I_{ds} is defined by using a function f(L, W) normalized by using gate length (L) and gate width (W). The function f(L, W) is defined by Eq. (5). In Eq. (5), values f0, f1, f2, f3 for the four vertexes or TEG sizes surrounding the point “▪” are used where they are obtained by normalizing by L/W the measured or interpolated values I_{ds}.

$$\begin{matrix}{I}_{ds} ( sat ) = \frac{W}{L} f ( L , W ) , \\ and & ( 4 ) \\ f ( L , W ) = \frac{\begin{matrix}( W - {W}_{1} ) \{ \frac{( {L}_{1} - L ) {f}_{0} + ( L - {L}_{0} ) {f}_{1}}{( L - {L}_{0} ) + ( {L}_{1} - L )} \} + \\ ( {W}_{2} - W ) \{ \frac{( {L}_{1} - L ) {f}_{2} + ( L - {L}_{0} ) {f}_{3}}{( L - {L}_{0} ) + ( {L}_{1} - L )} \}\end{matrix}}{( W - {W}_{1} ) + ( {W}_{2} - W )} . & ( 5 )\end{matrix}$$

In this way, by multiplying f by W/L as shown in Eq. (4), the current value I_{ds} for point “▪” can be obtained. Note that it is supposed that f changes linearly in L and W directions in a region surrounded by the TEG.

As explained so far, electric characteristics (in this example, current values) of devices of non-existing TEG sizes can be predicted with interpolation in the present embodiment. It is accordingly possible to realize a TEG design while avoiding increase in a TEG area in chip area or other factors where a large variety of device sizes is required. Further, if prediction accuracy is not import, it is possible to obtain desired values rapidly.

Because verification and evaluation of errors are performed between interpolated values and simulated values, it can be confirmed that no anomalies are present in the simulated values. Such confirmation may be automated through processes employing computers. It is accordingly possible to review behaviors of electric characteristics on devices with non-existing TEG sizes when parameters of circuit simulation models are extracted.

Moreover, vertexes and interpolated values between them obtained in the above-mentioned manner may be treated as actually measured values for extracting parameters of circuit simulation models. This means that it is possible to obtain model parameter sets having channel length/width sizes for individual transistors used for circuit design. Because parameters may be extracted for sizes not included in TEG, fitting parameters can be determined easily, while abnormal values for calculated values of parameters can be prevented. When performing local binning, it is possible to obtain calculated values completely for size-dependent parameters by setting virtual measured points when vertexes of bins are deficient.

Second Embodiment.

Circuit simulation is possible, without using analytic models as in the first embodiment, but with reference to a table of electric characteristics that have been preliminarily measured. A circuit simulation model employing such a table is called table model. In table model, current value for sizes other than table sizes may be predicted from a plurality of preliminarily input data in the table by using the method of first Embodiment.

FIG. 8 is used to illustrate an example of circuit simulation employing table model. In FIG. 8, a size at (L1, W1) that is an object for simulation is illustrated by a rectangle indicated with hatching. Measured current values at different sizes are first provided. Interpolated values obtained by the interpolation explained in the first embodiment may be included in the measured current values. By using these values, current value at the position of the target is calculated by the interpolation formula Eq. (5). In FIG. 8, electric characteristics at the position (L, W)=(L1, W1) will be predicted (or interpolated) on the basis of data of four sizes surrounding the position (denoted as sizes “1” to “4” in FIG. 8). When data of a target size is calculated, the accuracy of the calculated value can be improved by using prediction on the basis of a table having data of a plurality of sizes.

In the present embodiment, instead of the above-mentioned calculation by using a designated table of measuring data of a plurality of sizes, it is possible to provide a table set having a matrix pattern similarly to the size matrix used in the first embodiment and to interpolate current value for a size in the matrix pattern. Then, as explained above on the first embodiment, a size or position deficient in the table when the table is created can be complemented. Therefore, it will not be necessary to individually designate models of MOSFETs as in the prior art, but the simulator can select characteristic data of MOSFETs according to respective device sizes.

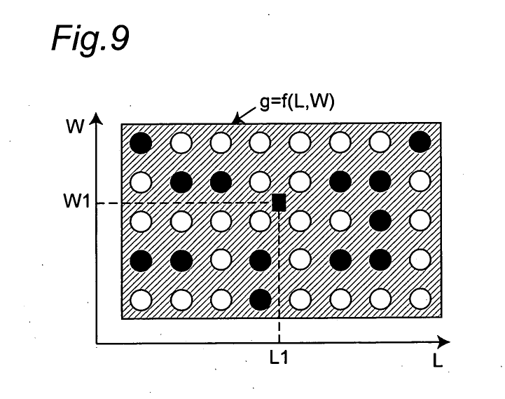

By using this method, data of an arbitrary size can be predicted for simulation from a small amount of data in a response curved surface. FIG. 9 illustrates a function g of gate size L/W obtained from a plurality of measured points. The function g is defined as g=f(L, W). The value at a target size (L1, W1) may be obtained by using the function g. By defining the function g of a multidimensional curved plane of L-W plane, an amount of sizes to be measured may be reduced. By determining a curved surface from a plurality of measured values, errors in measurement or influences of scattering of device characteristics on interpolated values may be reduced. By extracting parameters upon defining functions g of multidimensional surfaces of L-W planes, measurement errors in the extracted parameters or incorporated scattering in device characteristics may be reduced.

First and second embodiments of the present invention are explained so far. In the first Embodiment, Eqs. (1) to (5) are used for generating interpolated values. However, by changing these equations, it is possible to improve the accuracy of interpolation (prediction accuracy) further. An example will now be explained for increasing the accuracy of interpolated values by using actually measured values.

Since gate voltage Vₜₕ of MOSFET depends on the shape of MOSFET, target gate voltage is corrected at respective sizes to select data that form a basis for simulation. Threshold voltage is calculated from a table of data on preliminarily measured sizes, and the interpolation is performed with a current value at corrected gate voltage V_{gs}′, obtained by shifting a threshold by an amount for a device having a maximum gate width and a maximum gate length (or a reference device, that is, one of a group of data that form the basis for interpolation). After interpolation, such values are stored in the table as current values at gate voltages prior to correction.

Now, a simple calculation model is explained. A drain-source current of a MOSFET is defined by Eq. (6) in a linear region, and by Eq. (7) in a saturation region. In these equations, the gate voltage prior to correction is represented by “Vgs”.

$$\begin{matrix}{I}_{ds} = {μ}_{n} {C}_{ax} \frac{W}{L} ( {V}_{gs} - {V}_{th} - \frac{{V}_{ds}}{2} ) Vds , \\ and & ( 6 ) \\ {I}_{ds} = \frac{{μ}_{n} {C}_{ax}}{2} \frac{W}{L} {( {V}_{gs} - {V}_{th} )}^{2} . & ( 7 )\end{matrix}$$

Since the threshold voltage Vₜₕ depends on a shape of MOSFET, V_{gs} is preliminarily shifted by Vₜₕ from the reference device. As a result, the gate voltage is represented as V_{gs}−Vₜₕ=V_{gs}′. In the interpolation between data with the same V_{gs}′, an error in interpolation caused by L-dependent Vₜₕ may be cancelled to obtain desired interpolated value I_{ds}. In other words, by changing the interpolation functions, it is possible to obtain interpolated values of higher reliability. Needless to say, verification and evaluation may be performed by using such an interpolated value in the simulation system 10. By defining a plurality of interpolated values in multidimensional surface of L-W plane, it is possible to reduce the amount of sizes to be measured further. By determining the curved surface based on measured values, it is possible to reduce influence of measurement error or error of device characteristics on interpolated values. Thus, measurement error between simulated values and actual measurement data or factors causing erroneous verification owing to scattering of data may be reduced.

Simulation on current value, that is, drain-source current of MOSFET is explained in the examples explained above. However, the electric characteristic is not limited to the drain-source current as long as the electric characteristic may be calculated in circuit simulation by using interpolation of measured data. For instance, interpolation is possible by using threshold-voltage instead of current value. When a parameter other than drain-source current is used, after interpolated values are obtained, a system similar to the simulation system 10 employing the interpolated value can be constructed for performing the verification and evaluation. The extraction of parameters explained in the first embodiment and the circuit simulation employing table model explained in the second embodiment can be performed similarly. Thus, advantages similar to those as explained in the above embodiments may be achieved. By combining the above-mentioned modified examples, it is possible to improve the prediction accuracy, accuracy of verification and reliability.

According to the present invention, electric characteristics of transistors that have not been measured are interpolated on the basis of electric characteristics that have been measured on some transistors, and at least either of measured data or interpolated data can be used for the interpolation, and data of electric characteristics of arbitrary sizes can be obtained. Since electric characteristics of transistors which have not been measured may be predicted, an occupation ratio of chip sizes in a semiconductor device can be decreased when a large variety of device sizes is required for design.

Although the present invention has been fully described in connection with the preferred embodiments thereof with reference to the accompanying drawings, it is to be noted that various changes and modifications are apparent to those skilled in the art. Such changes and modifications are to be understood as included within the scope of the present invention as defined by the appended claims unless they depart therefrom.

What is claimed is:

1. A method for simulating an electric characteristic of a circuit including transistors, comprising the steps of;
arranging a plurality of transistors in a matrix pattern on the basis of sizes of the transistors, and storing data of the electric characteristic measured on first transistors among the plurality of transistors in the matrix pattern;
when a position of a second transistor different from the first transistors is specified in the matrix pattern, determining data of the electric characteristic of the second transistor according to interpolation rules by using the measured data of the one or more first transistors if there are one or more first transistors in the plurality of first transistor at one or more positions adjacent to the position of the second transistor in the matrix pattern; and
when a position of a third transistor different from the first and second transistors is specified in the matrix pattern, determining data of the electric characteristic of the third transistor according to the interpolation rules by using the measured data of the one or more first transistors and/or the interpolated data of the second transistor if there are one or more first transistors in the plurality of first transistor and/or one or more second transistor at one or more positions adjacent to the position of the third transistor in the matrix pattern.

2. The method as claimed in claim 1, wherein the sizes of the plurality of transistors include gate length and gate width, the matrix pattern is a two-dimensional pattern of gate length and gate width, and the interpolation rules are defined on the basis of a function of the gate length and the gate width of the transistors.

3. The method as claimed in claim 1, wherein the interpolation rules are defined on the basis of a function of gate voltage of the plurality of transistors wherein threshold voltage thereof is taken into account.
